(19) United States
(12) Patent Application Publication
(10) Pub. No.: US 2025/0212275 A1
(43) Pub. Date: Jun. 26, 2025

(54) EHT MULTI-LINK OPERATING CHANNEL VALIDATION IN WIRELESS COMMUNICATIONS

(71) Applicant: MEDIATEK INC., Hsinchu City (TW)

(72) Inventors: Yongho SEOK, San Jose, CA (US); Gabor BAJKO, San Jose, CA (US); James Chih-Shi YEE, San Jose, CA (US)

(21) Appl. No.: 18/850,896

(22) PCT Filed: Mar. 28, 2023
(86) PCT No.: PCT/CN2023/084476

§ 371 Date: Sep. 25, 2024

Related U.S. Application Data
(60) Provisional application No. 63/324,668, filed on Mar. 29, 2022.

(51) Int. Cl. H04W 76/15; H04W 28/06; H04W 72/0453

(52) U.S. Cl. CPC H04W 76/15; H04W 28/06; H04W 72/0453

(57) ABSTRACT

A station (STA) affiliated with a multi-link device (MLD) receives a respective frame from each of one or more peer STAs on one or more channels in a multi-link operation. The STA performs an operating channel validation regarding a respective channel used by the STA to communicate with each of the one or more peer STAs based on channel center frequency information comprised in operating channel information (OCI) indicated in an OCI element contained in the respective frame.

### CROSS REFERENCE TO RELATED PATENT APPLICATION(S)

The present disclosure is part of a non-provisional patent application claiming the priority benefit of U.S. Provisional Patent Application No. 63/324,668, filed 29 Mar. 2022, the content of which being herein incorporated by reference in its entirety.

### TECHNICAL FIELD

The present disclosure is generally related to wireless communications and, more particularly, to a technique of extremely-high-throughput (EHT) multi-link (ML) operating channel validation in wireless communications.

### BACKGROUND

Unless otherwise indicated herein, approaches described in this section are not prior art to the claims listed below and are not admitted as prior art by inclusion in this section.

In wireless communications such as EHT ML operations in a wireless local area network (WLAN) according to Institute of Electrical and Electronics Engineers (IEEE) 802.11 standard(s), there is an ever-present risk of channel-based man-in-the-middle (MITM) attacks. During an MITM attack, the attacker uses the medium access control (MAC) address of an access point (AP) on one channel (e.g., Channel A) and uses a MAC address of a station (STA) on another channel (e.g., Channel B). While the attacker may relay frames between the AP and STA, the attacker may also buffer frames and/or drop acknowledgement (ACK) frames to cause retransmissions. Therefore, there is a need for a solution of EHT ML operating channel validation in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to EHT ML operating channel validation in wireless communications. Under various proposed schemes in accordance with the present disclosure, issues described herein may be addressed.

In one aspect, a method may involve a station (STA) affiliated with a multi-link device (MLD) receiving a respective frame from each of one or more peer STAs on one or more channels in a multi-link operation. The method may also involve the STA performing an operating channel validation regarding a respective channel used by the STA to communicate with each of the one or more peer STAs based on channel center frequency information comprised in operating channel information (OCI) indicated in an OCI element contained in the respective frame.

In another aspect, an apparatus implementable in an MLD may include a transceiver and a processor coupled to the transceiver. The transceiver may be configured to communicate wirelessly. The processor may, as a STA affiliated with the MLD, be configured to receive, via the transceiver, a respective frame from each of one or more peer STAs on one or more channels in a multi-link operation. The processor may also be configured to perform an operating channel validation regarding a respective channel used by the STA to communicate with each of the one or more peer STAs based on channel center frequency information comprised in OCI indicated in an OCI element contained in the respective frame.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design in accordance with an implementation of the present disclosure.

FIG. 3 is a diagram of an example scenario in accordance with an implementation of the present disclosure.

FIG. 4 is a diagram of an example design in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to EHT ML operating channel validation in wireless communications. According to the present disclosure, a number of possible solutions may be implemented separately or jointly. That is, although these possible solutions may be described below separately, two or more of these possible solutions may be implemented in one combination or another.

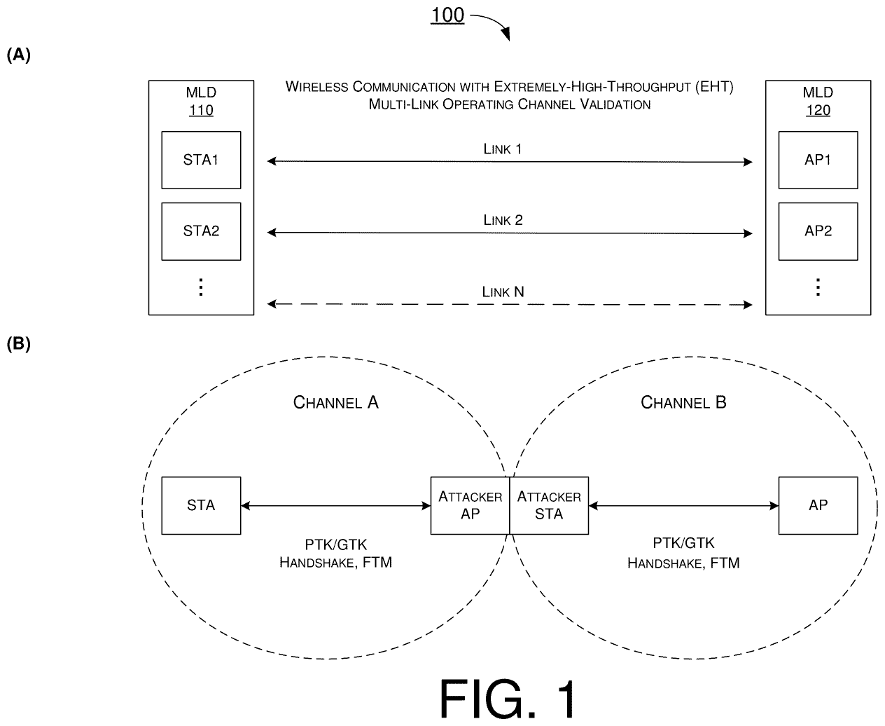

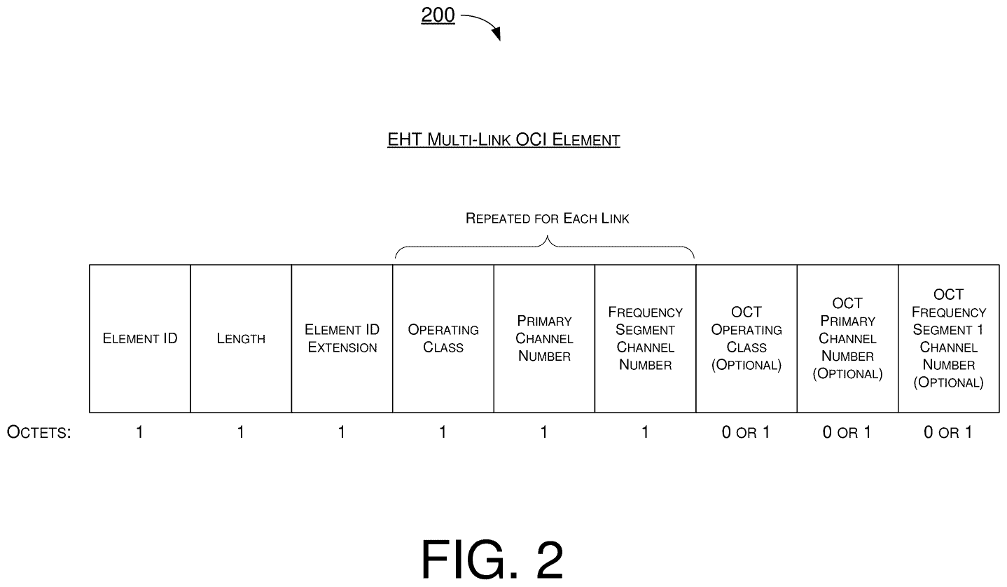

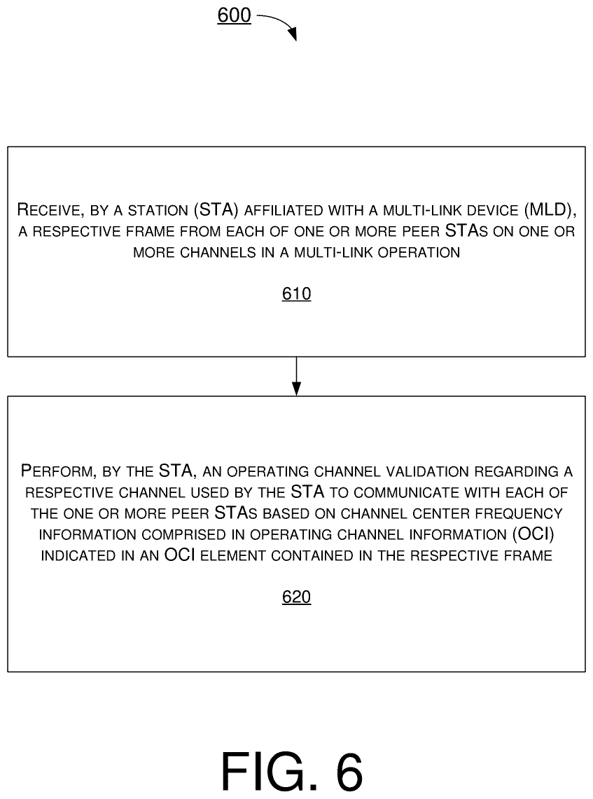

FIG. 1 illustrates an example network environment 100 in which various solutions and schemes in accordance with the present disclosure may be implemented. FIG. 2˜FIG. 6 illustrate examples of implementation of various proposed schemes in network environment 100 in accordance with the present disclosure. The following description of various proposed schemes is provided with reference to FIG. 1˜FIG. 6.

Referring to part (A) of FIG. 1, network environment 100 may involve a first MLD (MLD 110) and a second MLD (MLD 120) communicating wirelessly over multiple links (e.g., link 1 and link 2) with each other in a basic service set (BSS) in accordance with one or more IEEE 802.11 standards. Each of MLD 110 and MLD 120 may function as a non-AP MLD with multiple virtual STAs affiliated therewith or, alternatively, may function as an AP MLD with multiple virtual APs affiliated therewith. For illustrative purposes and without limiting the scope of the present disclosure, MLD 110 is shown to be a non-AP MLD with a number of affiliated non-AP STAs (e.g., STA 11 and STA 12) and MLD 120 is shown to be an AP MLD with a number of affiliated AP STAs (e.g., AP 1 and AP 2). It is noteworthy that, although a certain number of STAs (e.g., two) is shown to be affiliated with each of MLD 110 and MLD 120, in actual implementations a number N of STAs affiliated with each of MLD 110 and MLD 120 and the number of corresponding links therebetween may be the same or different. Under various proposed schemes in accordance with the present disclosure, MLD 110 and MLD 120 may be configured to perform EHT ML operating channel validation in wireless communications according to various proposed schemes described herein. It is noteworthy that the various proposed schemes may be implemented individually or, alternatively, jointly (e.g., two or more of the proposed schemes implemented together), even though each of the various proposed schemes may be described separately below.

Referring to part (B) of FIG. 1, during a channel-based MITM attack, an attacker may use the MAC address of an AP (e.g., one of the APs affiliated with MLD 120) to pretend to be that AP on one channel (e.g., Channel A) and the attacker may also use a MAC address of a STA (e.g., one of the STAs affiliated with MLD 110) to pretend to be that STA on another channel (e.g., Channel B, which is different from Channel A). That is, the attacker may pretend to be the STA on Channel B in communicating with the AP while pretending to be the AP on Channel A in communicating with the STA. This may cause the AP to erroneously determine that STA is operating on Channel B and, likewise, this may also cause the STA to erroneously determine that AP is operating on Channel A. While the attacker may relay frames between the AP and STA, the attacker may also buffer frames and/or drop ACK frames to achieve malicious goals such as causing retransmissions, thereby degrading overall system performance.

When an Operating Channel Validation Capable (OCVC) capability is present, a STA may advertise this capability in a Robust Security Network Element (RSNE), and the STA may include operating channel information and validate Operating Channel Information (OCI) received from an OCVC-capable peer in certain protected messages (e.g., management frames) used for key establishment and confirmation. That is, the STA with OCVC capability may validate that the channel information in the received OCI matches its current operating channel parameters by performing certain operations. That is, most management frames may contain an OCI element that indicates the operating channel number, and such management frames are encrypted (protected). Upon receiving multiple management frames each containing a respective OCI element, the STA can determine whether such management frames are sent on the same channel or different channels. Accordingly, in the channel-based MTIM attack scenario shown in part (B) of FIG. 1, based on the operating channel being indicated in the OCI clement contained in a received management frame to be Channel B, while the STA is operating on Channel A, the STA may determine that the management frame is transmitted by (and received from) an attacker instead of a genuine AP operating on Channel A. For instance, the STA may verify that the maximum bandwidth used by the STA to transmit and/or receive physical-layer protocol data units (PPDUs) to and/or from the peer STA from which the OCI was received is not greater than the bandwidth of the operating class specified in an Operating Class field of the received OCI. Additionally, or alternatively, the STA may verify that the primary channel used by the STA to transmit and/or receive PPDUs to and/or from the peer STA from which the OCI was received is equal to the Primary Channel Number field (for the corresponding operating class). Additionally, or alternatively, the STA may verify that, when a 40 MHz bandwidth is used by the STA to transmit and/or receive PPDUs to and/or from the peer STA from which the OCI was received, a nonprimary 20 MHz channel used matches the operating class (e.g., upper/lower behavior) specified in the Operating Class field of the received OCI. Additionally, or alternatively, the STA may verify that, in case of operating in an (80+80) MHz operating class, the frequency segment 1 channel number used by the STA to transmit and/or receive PPDUs to and/or from the peer STA from which the OCI was received is equal to a Frequency Segment Channel Number field of the OCI. The Frequency Segment Channel Number field sometimes can be labeled as Frequency Segment 1 Channel number field.

In an event that a non-transmitting MAC Sublayer Management Entity (NT-MLME) of a STA with OCVC capability processes a Management MAC Protocol Data Unit (MMPDU) containing an OCI received in an MLME-OCTunnel.indication primitive in an On-Channel Tunneling (OCT) operation, then aforementioned validation may be performed with respect to the expected or current channel used by the STA to transmit and/or receive PPDUs to and/or from the peer STA over the wireless medium (e.g., not using the OCT procedure). In addition, the STA may verify that the OCI contains the OCT Operating Class, OCT Primary Channel Number and OCT Frequency Segment Channel Number fields. Moreover, the STA may use the OCT information in those fields to perform the above validation with respect to the channel used by the STA corresponding to a transmitting MLME (TR-MLME) from which the MLME-OCTunnel.indication primitive was received to transmit and/or receive PPDUs containing On-Channel Tunnel Request frames to and/or from the STA corresponding to the TR-MLME used by the peer STA. In an event that a STA with OVOC capability receives a frame from a peer STA which is not on the same primary channel (or frequency segment 1 channel number) used by the STA to receive PPDUs from the peer STA or has bandwidth that exceeds the maximum bandwidth used by the STA to receive PPDUs from the peer STA, the frame may be discarded.

Moreover, with respect to operating channel validation, channel information that needs to be validated may be typically specified by operating class and the channel number. Since the use of the country string is being deprecated in favor of sole use of the global operating classes table, operating classes from the global table may be advertised in Beacons and probe responses. Thus, in validating OCI, a STA may validate the global operating class (that also defines bandwidth and primary channel upper/lower behaviour) and channel number. Specifying operating class, primary channel, and the frequency segment 1 channel number may be sufficient to indicate the operating channel information to cover 80 MHz and 80+80/160 MHZ cases where center frequency indices may be specified in the operating class table.

For example, for a very-high-throughput (VHT) 80 MHz BSS operating with an 80 MHZ Channel 155 (e.g., 5735˜5815 MHZ), which is operating class 128 with channel center frequency index 155, an AP may choose its primary 20 MHz channel anywhere in the primary 80 MHz channel (e.g., Channel 153, which is the second 20 MHz channel). The OCI may have the following value set: {Operating Class field=128, Primary Channel Number=153, Frequency Segment 1 Channel Number=0 (since not 80+80 MHZ)}. For a VHT (80+80) MHZ BSS operating with an 80 MHz Channel 155 (e.g., 5735˜5815 MHZ), which is operating class 130 with channel center frequency index 155 for the primary segment (frequency segment 0) and 42 for the secondary segment (frequency segment 1), the AP may choose its primary 20 MHz channel anywhere in the primary 80 MHZ (e.g., Channel 153, which is the second 20 MHz channel). The OCI may have the following value set: {Operating Class field=130, Primary Channel Number=153, Frequency Segment 1 Channel Number=42}. The Operating Class indicated in the OCI element represents the widest bandwidth currently being used by the transmitting STA. For example, in case that a VHT 80 MHz AP has an associated STA that only supports 20 MHZ, the OCI element from the AP needs to indicate the 80 MHz Operating Class. On the other hand, in case that a non-AP STA supports 80 MHz but the AP supports only 40 MHz and the AP is sending a PPDU containing OCI element at a 20 MHz bandwidth in the primary sub-channel, the OCI element needs to indicate the 40 MHz Operating Class since that is the widest bandwidth the AP (or transmitting STA) is using.

For operating channel validation, the OCI may need to be included in certain types of messages. For instance, the OCI may be included in 4-way handshake M2 and M3 messages. Alternatively, or additionally, the OCI may be included in group temporal key (GTK) handshake messages. Alternatively, or additionally, the OCI may be included in fast BSS transition (FT) re-association messages (e.g., request and response). Alternatively, or additionally, the OCI may be included in fast initial link setup (FILS) re-association messages (e.g., request and response). Alternatively, or additionally, the OCI may be included in Authenticated Mesh Peering Exchange (AMPE) handshake messages (e.g., Mesh Peering Management frames). Alternatively, or additionally, the OCI may be included in Wireless Network Management (WNM) sleep mode messages (e.g., request and response). Channel switch announcements may contain target and/or new channel information. These announcements may be protected by a Protected Management Frame (PMF)—assuming the PMF is being used, but PMF does not apply to beacons/probe responses which can contain a channel switch announcement element. A reasonable position is to require PMF when OCV protection is required for channel switch-at least protect PMF environments—as PMF is likely to be available in most devices now or in the near future. Security Association (SA) query may be extended and used after a channel switch to validate OCI. Moreover, Fine Timing Measurement (FTM) exchanges may be indirectly protected as they do not negotiate the channel currently. In case that a channel is confirmed by another secure handshake, multi-channel MITM threat may be alleviated.

FIG. 2 illustrates an example design 200 of an EHT multi-link OCI element under a proposed scheme in accordance with the present disclosure. Referring to FIG. 2, the EHT multi-link OCI element in design 200 may be an extension of an existing format of OCI elements with some of the fields being repeated for each link of multiple links of the multi-link operation. Fields in the EHT multi-link OCI element may include, among others, an Operating Class field, a Primary Channel Number field, and a Frequency Segment 1 Channel Number field. In design 200, these three fields may be repeated for each link of multiple links in use for multi-link operation. The Operating Class field may be set to a global operating class that corresponds to the widest bandwidth currently being used by the transmitting STA. The Primary Channel Number field is set to the primary channel being used currently. Moreover, the Primary Channel Number field may be one of the channels from the row corresponding to the operating class or the primary 20 MHZ (sub) channel allowed for high-throughput (HT) or non-HT operation for operating classes that specify only channel center frequency indices. The Frequency Segment 1 Channel Number field may be set to the channel center frequency index of the secondary segment (frequency segment 1) being used currently, if applicable, or set to 0 otherwise. For instance, the value of the Frequency Segment 1 Channel Number field may be one of the center frequency indices from the row corresponding to the operating class.

Under the proposed scheme, for each link of multiple links, the Operating Class field may be set to the global operating class that corresponds to the widest bandwidth currently being used by the transmitting STA. For each link, the Primary Channel Number field may be set to the primary channel being used currently. The Primary Channel Number field may be one of the channels from the row corresponding to the operating class or the primary 20 MHZ (sub) channel allowed for HT or non-HT operation for operating classes that specify only channel center frequency indices. For each link, when the operating channel bandwidth is 20 MHz, 40 MHz, 80 MHz, 160 MHz or 80+80 MHz, the Frequency Segment Channel Number field may be set to the channel center frequency index of the secondary segment (frequency segment 1) being used currently, if applicable, or set to 0 otherwise. The value of the Frequency Segment Channel Number field may be one of the center frequency indices from the row corresponding to the operating class. For each link, when the channel bandwidth is 320 MHZ, the Frequency Segment Channel Number field may be set to the channel center frequency index of the primary segment (frequency segment 0) being used currently or set to the center frequency of the 320 MHz channel so as to resolve the ambiguity caused by overlapping 320 MHz channelization. The value of the Frequency Segment Channel Number field may be one of the center frequency indices from the row corresponding to the operating class.

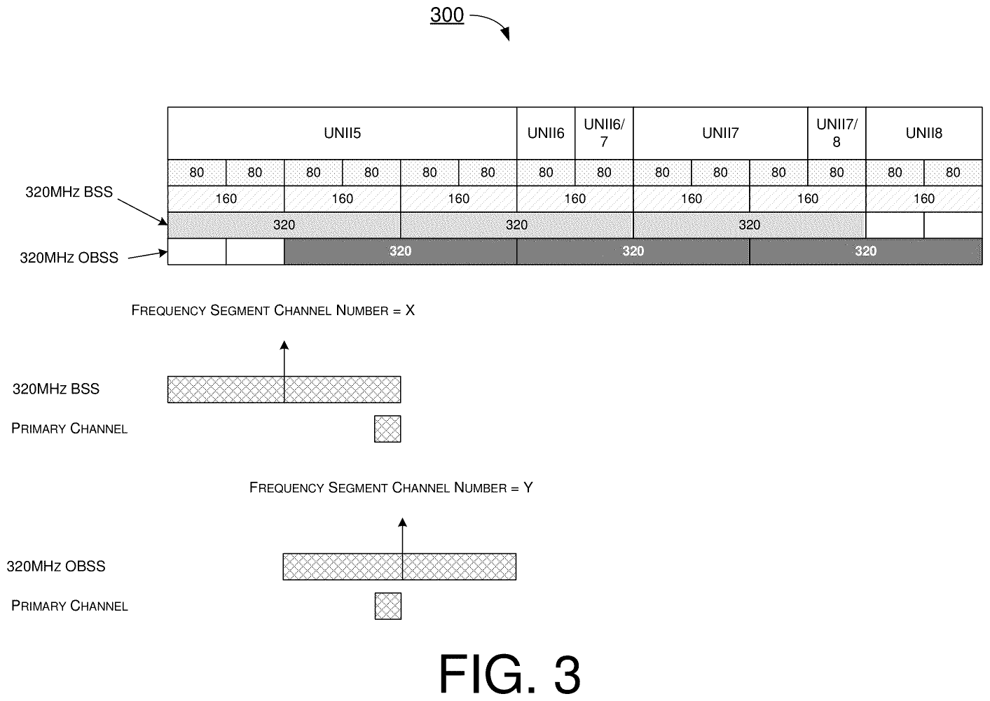

FIG. 3 illustrates an example scenario 300 showing implantation of the proposed scheme when the channel bandwidth is 320 MHz. In scenario 300, each of a given BSS and an overlapping BSS (OBSS) may be using a respective 320 MHz channel. As shown in FIG. 3, while the operating 320 MHz channels of the two BSSs are different, they nevertheless overlap with each other. Accordingly, without implementing the proposed schemes in accordance with the present disclosure, there may be ambiguity as to whether the operating channel of the BSS is the same as or different from the operating channel of the OBSS. Advantageously, since it is the center frequency of the 320 MHz operating channel that is indicated in the Frequency Segment Channel Number field of the OCI element, a STA receiving a management frame containing an OCI element from each of the BSS (with a value of frequency segment channel number being X) and the OBSS (with a value of frequency segment channel number being Y) may correctly discern which management frame is received from which of the BSS and OBSS, since the operating channels of the BSS and OBSS have different channel center frequencies (e.g., as X+Y), even if the BSS and OBSS use the same frequency band for their respective primary channels, as shown in FIG. 3.

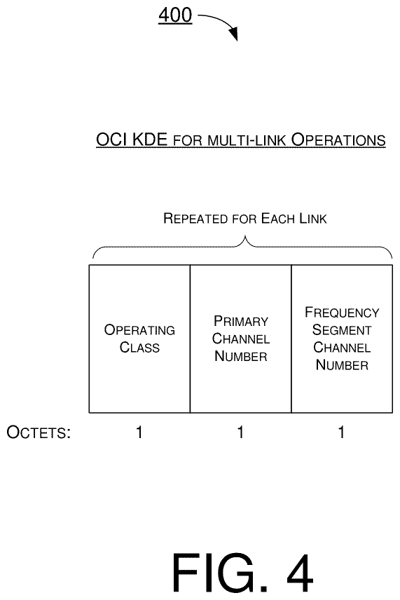

FIG. 4 illustrates an example design 400 of an OCI KDE for multi-link operations under a proposed scheme in accordance with the present disclosure. Referring to FIG. 4, there are multiple fields in the OCI KDE including, for example and without limitation, an Operating Class filed, a Primary Channel Number filed, and a Frequency Segment Channel Number field. These fields may be repeated for each link of multiple links of the multi-link operations.

Under the proposed scheme, for each link, the Operating Class field may be set to the global operating class that corresponds to the widest bandwidth currently being used by the transmitting STA. For each link, the Primary Channel Number field may be set to the primary channel being used currently. The Primary Channel Number field may be one of the channels from the row corresponding to the operating class or the primary 20 MHZ (sub) channel allowed for HT or non-HT operation for operating classes that specify only channel center frequency indices. For each link, when the operating channel bandwidth is 20 MHz, 40 MHz, 80 MHZ, 160 MHz or 80+80 MHz, the Frequency Segment Channel Number field may be set to the channel center frequency index of the secondary segment (frequency segment 1) being used currently, if applicable, or set to 0 otherwise. For each link, the value of the Frequency Segment Channel Number field may be one of the center frequency indices from the row corresponding to the operating class. For each link, when the operating channel bandwidth is 320 MHZ, the Frequency Segment Channel Number field may be set to the channel center frequency index of the primary segment (frequency segment 0) being used currently. The value of the Frequency Segment Channel Number field may be one of the center frequency indices from the row corresponding to the operating class.

### Illustrative Implementations

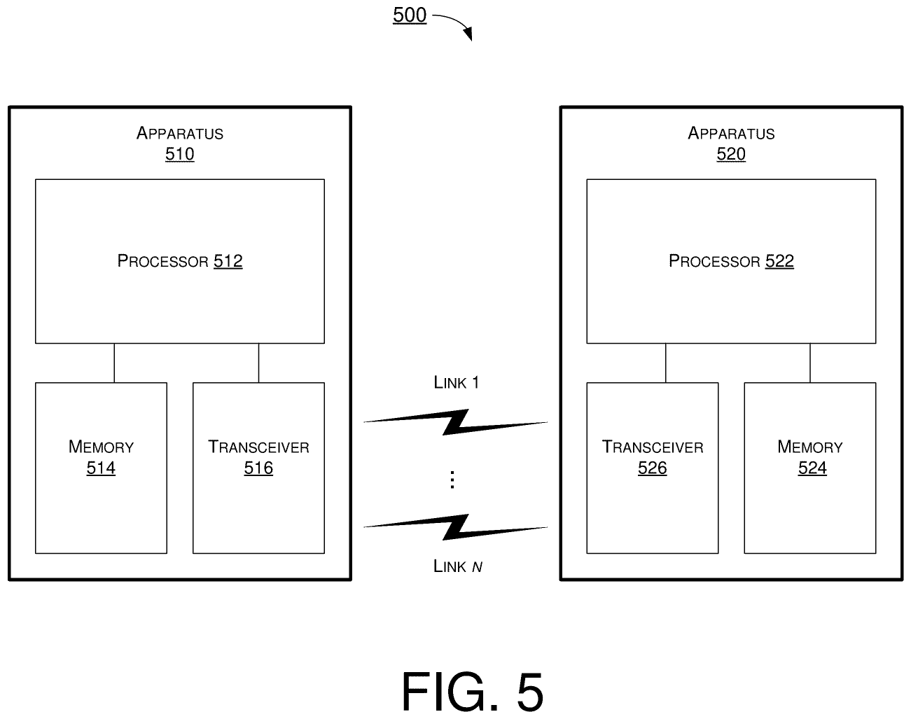

FIG. 5 illustrates an example communication system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to EHT ML operating channel validation in wireless communications, including the various schemes described above with respect to various proposed designs, concepts, schemes, systems and methods described above as well as processes described below. For instance, apparatus 510 may be an example implementation of MLD 110, and apparatus 520 may be an example implementation of MLD 120.

Each of apparatus 510 and apparatus 520 may be a part of an electronic apparatus such as, for example and without limitation, a portable or mobile apparatus, a wearable apparatus, a wireless communication apparatus or a computing apparatus. For instance, each of apparatus 510 and apparatus 520 may be implemented in a smartphone, a smart watch, a personal digital assistant, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in a network node, such as an AP in a WLAN.

In some implementations, each of apparatus 510 and apparatus 520 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, one or more RISC processors or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to EHT ML operating channel validation in wireless communications in accordance with various implementations of the present disclosure.

In some implementations, apparatus 510 may also include a transceiver 516 coupled to processor 512. Transceiver 516 may be capable of wirelessly transmitting and receiving data. In some implementations, apparatus 520 may also include a transceiver 526 coupled to processor 522. Transceiver 526 may include a transceiver capable of wirelessly transmitting and receiving data. Transceiver 516 of apparatus 510 and transceiver 526 of apparatus 520 may communicate each other over one or more of multiple links link 1˜link N, with N being a positive integer greater than 1, such as a first link and a second link.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), crasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of apparatus 510 and apparatus 520 may be a communication entity capable of communicating with each other using various proposed schemes in accordance with the present disclosure. For illustrative purposes and without limitation, a description of capabilities of apparatus 510, as MLD 110 which may be a non-AP MLD or an AP MLD, and apparatus 520, as MLD 120 which may be an AP MLD or a non-AP MLD, is provided below. It is noteworthy that, although the example implementations described below are provided in the context of WLAN, the same may be implemented in other types of networks.

Under a proposed scheme with respect to EHT ML operating channel validation in wireless communications in accordance with the present disclosure, processor 512 of apparatus 510, as a STA affiliated with a first MLD (e.g., MLD 110), may receive, via transceiver 516, a respective frame from each of one or more peer STAs (e.g., one or more peer STAs affiliated with apparatus 520 as a second MLD such as MLD 120) on one or more channels in a multi-link operation. Moreover, processor 512 may perform an operating channel validation regarding a respective channel used by the STA to communicate with each of the one or more peer STAs based on channel center frequency information comprised in OCI indicated in an OCI element contained in the respective frame.

In some implementations, the OCI element may include at least an Operating Class field, a Primary Channel Number field and a Frequency Segment Channel Number field which are repeated for each link of a plurality of links used in the multi-link operation.

In some implementations, in response to a bandwidth of the respective channel being 320 MHz, a value in the Frequency Segment Channel Number field may be set to a center frequency of the respective channel. Alternatively, in response to the bandwidth of the respective channel being 320 MHz, the value in the Frequency Segment Channel Number field may be set to a channel center frequency index of a primary segment being used currently.

In some implementations, in response to a bandwidth of the respective channel being not 320 MHz, a value in the Frequency Segment Channel Number field may be set to a channel center frequency index of a secondary segment being used currently. In some implementations, the bandwidth of the respective channel may be 20 MHz, 40 MHz, 80 MHz, 160 MHz or 80+80 MHz.

In some implementations, each of the one or more peer STAs may include an OCVC STA. In some implementations, in performing the operating channel validation, processor 512 may validate the OCI received in protected messages used in key establishment and confirmation with each of the one or more peer STAs by determining whether channel information in the OCI matches one or more parameters of a current operating channel of the STA.

In some implementations, processor 512 may discard, based on a result of the operating channel validation, the respective frame responsive to the respective frame being not on a same primary channel used by the STA to receive one or more PPDUs from a respective one of the one or more peer STAs. Alternatively, or additionally, processor 512 may discard, based on the result of the operating channel validation, the respective frame responsive to the respective frame having a bandwidth exceeding a maximum bandwidth used by the STA to receive the one or more PPDUs from the respective one of the one or more peer STAs.

### Illustrative Processes

FIG. 6 illustrates an example process 600 in accordance with an implementation of the present disclosure. Process 600 may represent an aspect of implementing various proposed designs, concepts, schemes, systems and methods described above. More specifically, process 600 may represent an aspect of the proposed concepts and schemes pertaining to EHT ML operating channel validation in wireless communications in accordance with the present disclosure. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed repeatedly or iteratively. Process 600 may be implemented by or in apparatus 510 and apparatus 520 as well as any variations thereof. Solely for illustrative purposes and without limiting the scope, process 600 is described below in the context of apparatus 510 as MLD 110 and apparatus 520 as MLD 120 of a wireless network such as a WLAN in accordance with one or more of IEEE 802.11 standards. Process 600 may begin at block 610.

At 610, process 600 may involve processor 512 of apparatus 510, as a STA affiliated with a first MLD (e.g., MLD 110), receiving a respective frame from each of one or more peer STAs (e.g., one or more peer STAs affiliated with apparatus 520 as a second MLD such as MLD 120) on one or more channels in a multi-link operation. Process 600 may proceed from 610 to 620.

At 620, process 600 may involve processor 512 performing an operating channel validation regarding a respective channel used by the STA to communicate with each of the one or more peer STAs based on channel center frequency information comprised in OCI indicated in an OCI element contained in the respective frame.

In some implementations, the OCI element may include at least an Operating Class field, a Primary Channel Number field and a Frequency Segment Channel Number field which are repeated for each link of a plurality of links used in the multi-link operation.

In some implementations, in response to a bandwidth of the respective channel being 320 MHz, a value in the Frequency Segment Channel Number field may be set to a center frequency of the respective channel. Alternatively, in response to the bandwidth of the respective channel being 320 MHz, the value in the Frequency Segment Channel Number field may be set to a channel center frequency index of a primary segment being used currently.

In some implementations, in response to a bandwidth of the respective channel being not 320 MHz, a value in the Frequency Segment Channel Number field may be set to a channel center frequency index of a secondary segment being used currently. In some implementations, the bandwidth of the respective channel may be 20 MHz, 40 MHz, 80 MHz, 160 MHz or 80+80 MHZ.

In some implementations, each of the one or more peer STAs may include an OCVC STA. In some implementations, in performing the operating channel validation, process 600 may involve processor 512 validating the OCI received in protected messages used in key establishment and confirmation with each of the one or more peer STAs by determining whether channel information in the OCI matches one or more parameters of a current operating channel of the STA.

In some implementations, process 600 may further involve processor 512 discarding, based on a result of the operating channel validation, the respective frame responsive to the respective frame being not on a same primary channel used by the STA to receive one or more PPDUs from a respective one of the one or more peer STAs. Alternatively, or additionally, process 600 may further involve processor 512 discarding, based on the result of the operating channel validation, the respective frame responsive to the respective frame having a bandwidth exceeding a maximum bandwidth used by the STA to receive the one or more PPDUs from the respective one of the one or more peer STAs.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds ‘true’ for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the ‘true’ scope and spirit being indicated by the following claims.

What is claimed is:

1. A method, comprising:
receiving, by a station (STA) affiliated with a multi-link device (MLD), a respective frame from each of one or more peer STAs on one or more channels in a multi-link operation; and
performing, by the STA, an operating channel validation regarding a respective channel used by the STA to communicate with each of the one or more peer STAs based on channel center frequency information comprised in operating channel information (OCI) indicated in an OCI element contained in the respective frame.

2. The method of claim 1, wherein responsive to a bandwidth of the respective channel being 320 MHz, a value in the Frequency Segment Channel Number field is set to a center frequency of the respective channel.

3. The method of claim 1, wherein responsive to a bandwidth of the respective channel being 320 MHz, a value in the Frequency Segment Channel Number field is set to a channel center frequency index of a primary segment being used currently.

4. The method of claim 1, wherein responsive to a bandwidth of the respective channel being not 320 MHz, a value in the Frequency Segment Channel Number field is set to a channel center frequency index of a secondary segment being used currently.

5. The method of claim 4, wherein the bandwidth of the respective channel is 20 MHz, 40 MHz, 80 MHz, 160 MHz or 80+80 MHz.

6. The method of claim 1, wherein each of the one or more peer STAs comprises an Operating Channel Validation Capable (OCVC) STA.

7. The method of claim 6, wherein the performing of the operating channel validation comprises validating the OCI received in protected messages used in key establishment and confirmation with each of the one or more peer STAs by determining whether channel information in the OCI matches one or more parameters of a current operating channel of the STA.

8. The method of claim 1, further comprising:
discarding, by the STA based on a result of the operating channel validation, the respective frame responsive to the respective frame being not on a same primary channel used by the STA to receive one or more physical-layer protocol data units (PPDUs) from a respective one of the one or more peer STAs.

9. The method of claim 1, further comprising:
discarding, by the STA based on a result of the operating channel validation, the respective frame responsive to the respective frame having a bandwidth exceeding a maximum bandwidth used by the STA to receive one or more physical-layer protocol data units (PPDUs) from the respective one of the one or more peer STAs.

10. A method, comprising:
receiving, by a station (STA) affiliated with a multi-link device (MLD), a respective frame from each of one or more peer STAs on one or more channels in a multi-link operation; and
performing, by the STA, an operating channel validation regarding a respective channel used by the STA to communicate with each of the one or more peer STAs based on channel center frequency information comprised in operating channel information (OCI) indicated in an OCI element contained in the respective frame,
wherein the OCI element comprises at least an Operating Class field, a Primary Channel Number field and a Frequency Segment Channel Number field which are repeated for each link of a plurality of links used in the multi-link operation.

11. An apparatus implementable in a multi-link device (MLD), comprising:
a transceiver configured to communicate wirelessly; and
a processor coupled to the transceiver and configured to perform, via the transceiver, operations comprising:
receiving, as a station (STA) affiliated with the MLD, a respective frame from each of one or more peer STAs on one or more channels in a multi-link operation; and
performing, as the STA, an operating channel validation regarding a respective channel used by the STA to communicate with each of the one or more peer STAs based on channel center frequency information comprised in operating channel information (OCI) indicated in an OCI element contained in the respective frame.

12. The apparatus of claim 11, wherein the OCI element comprises at least an Operating Class field, a Primary Channel Number field and a Frequency Segment Channel Number field which are repeated for each link of a plurality of links used in the multi-link operation.

13. The apparatus of claim 11, wherein responsive to a bandwidth of the respective channel being 320 MHz, a value in the Frequency Segment Channel Number field is set to a center frequency of the respective channel.

14. The apparatus of claim 11, wherein responsive to a bandwidth of the respective channel being 320 MHz, a value in the Frequency Segment Channel Number field is set to a channel center frequency index of a primary segment being used currently.

15. The apparatus of claim 11, wherein responsive to a bandwidth of the respective channel being not 320 MHz, a value in the Frequency Segment Channel Number field is set to a channel center frequency index of a secondary segment being used currently.

16. The apparatus of claim 15, wherein the bandwidth of the respective channel is 20 MHz, 40 MHz, 80 MHz, 160 MHz or 80+80 MHz.

17. The apparatus of claim 11, wherein each of the one or more peer STAs comprises an Operating Channel Validation Capable (OCVC) STA.

18. The apparatus of claim 17, wherein the performing of the operating channel validation comprises validating the OCI received in protected messages used in key establishment and confirmation with each of the one or more peer STAs by determining whether channel information in the OCI matches one or more parameters of a current operating channel of the STA.

19. The apparatus of claim 11, wherein the processor is further configured to perform operations comprising:
discarding, based on a result of the operating channel validation, the respective frame responsive to the respective frame being not on a same primary channel used by the STA to receive one or more physical-layer protocol data units (PPDUs) from a respective one of the one or more peer STAs.

20. The apparatus of claim 11, wherein the processor is further configured to perform operations comprising:
discarding, based on a result of the operating channel validation, the respective frame responsive to the respective frame having a bandwidth exceeding a maximum bandwidth used by the STA to receive one or more physical-layer protocol data units (PPDUs) from the respective one of the one or more peer STAs.
